(19) United States
(12) Patent Application Publication
(10) Pub. No.: US 2005/0268656 A1
(43) Pub. Date: Dec. 8, 2005

(54) Poly-crystalline compositions

(76) Inventors: Alexander Raichel, Rishon LeZion (IL); Amir Nachumi, Ramat-HaSharon (IL); Svetlana Raichel, Rishon LeZion (IL)

Correspondence Address: MARTIN MOYNIHAN;c/o ANTHONY CASTORINA, SUITE 207, 2001 JEFFERSON DAVIS HIGHWAY, ARLINGTON, VA, 22202, US

(21) Appl. No.: 11/140,927

(22) Filed: Jun. 1, 2005

Related U.S. Application Data
(63) Continuation-in-part of application No. 10/928,723, filed on Aug. 30, 2004.
Application No. 10/928,723 is a continuation-in-part of application No. 10/047,395, filed on Jan. 8, 2002, now Pat. No. 6,825,139.
(60) Provisional application No. 60/259,901, filed on Jan. 8, 2001.
(60) Provisional application No. 60/575,370, filed on Jun. 1, 2004.

(51) Int. Cl. C03C 10/10

(52) U.S. Cl. 65/33.7; 65/134.3; 65/19

(57) ABSTRACT

The invention discloses methods for the preparation of poly-crystaline materials such as glass-ceramics.

This application is a continuation-in-part of U.S. patent application Ser. No. 10/928,723, filed Aug. 30, 2004, which is a continuation-in-part of U.S. patent application Ser. No. 10/047,395, filed Jan. 8, 2002, now U.S. Pat. No. 6,825,139, which claims the benefit of U.S. Provisional Patent Application No. 60/259,901, filed Jan. 8, 2001.

U.S. patent application Ser. No. 10/928,723 also claims the benefit of U.S. Provisional Patent Application No. 60/575,370, filed Jun. 1, 2004.

The above Applications are hereby incorporated by reference as if fully set forth herein.

### FIELD AND BACKGROUND OF THE INVENTION

The present invention relates to glass-ceramic compositions, articles of manufacture and processes for producing the same.

Coal ash is the incombustible non-volatile mineral residue resulting from the burning of coal in power stations. The quantity of ash produced depends on the composition of the coal and generally ranges from 5% to 13% of the total mass of the coal. Municipal solid waste coal ash is the incombustible non-volatile mineral residue resulting from the burning of solid wastes. Disposing of the great amount of these ashes formed is difficult and is thus considered a major environmental challenge. Industrial developed countries, which are producing considerable quantities of electric power, face the problem of accumulating huge quantities of coal ash waste.

Generally, about 20% by weight of coal ash is relatively large “bottom ash” gathered from the bottom of a furnace and about 80% by weight is relatively small “fly ash” comprising small particles gathered from the flue and chimney of a furnace.

In most countries, some the coal ash is used in cement as a substitute for shale; in concrete as a substitute for cement and sand; in road construction as filler for bitumen and in bricks as a substitute for clay. Despite these uses, vast amounts of coal ash remain unexploited and must be disposed.

U.S. Pat. No. 5,521,132 by Talmy et al., teaches a method of manufacturing ceramic materials on the base of ash from coal and solid municipal waste incineration, mixed with sodium tetraborate and a calcium containing material.

U.S. Pat. No. 5,583,079 by Golitz, et al., teaches a method of ceramic products obtained by mixing coal ash, glass and clay wastes.

U.S. Pat. No. 3,966,9122 to Miller et al., teaches a method of manufacturing of soda-lime glass containing coal ash.

U.S. Pat. No. 4,430,108 to Hojaji et al., teaches a method of manufacturing foam glass from diatomaceous and coal ash.

U.S. Pat. No. 5,935,885 to Hnat et al., teaches a method for forming glass ceramic tiles.

The above methods produce glass products having properties similar to glass material that exist in the market. However, glass materials made from coal ash are generally black due to the high iron content of coal ash, limiting potential applications of such products.

There is thus a widely recognized need for cost effective processes and for high added-value products made from coal ash. It would be preferable to produce high quality glass poly-crystalline (e.g., glass-ceramic) products due to the high impact strength, high compressive strength, high bending strength high hardness, modulus of elasticity, thermal-resistance, high-temperature strength, wear-resistance, absence of porosity, zero water-absorption, gas-impermeability and low thermal conductivity as compared to glass.

### SUMMARY OF THE INVENTION

At least some of the objectives above are achieved by the teachings of the present invention.

In one embodiment, the invention provides a poly-crystalline composition comprising an amount of SiO₂, Al₂O₃, CaO, Fe₂O₃, TiO₂, MgO, Na₂O, Li₂O, CeO₂, ZrO₂, K₂O, P₂O₅, Cr₂O₃, ZnO and MnO₂.

In another embodiment, the invention provides a process for producing a poly-crystalline composition comprising the steps of: mixing a coal ash particle with at least one glass forming agent and at least one crystallization catalyst; melting said coal ash particle, the at least one glass forming agent and the at least one crystallization catalyst to form a mixture; and cooling the resulting mixture to ambient temperature so as to form a homogenous, non-porous poly-crystalline product comprising SiO₂, Al₂O₃, CaO, Fe₂O₃, TiO₂, MgO, Na₂O, Li₂O, CeO₂, ZTO₂, K₂O, P₂O₅, Cr₂O₃, ZnO and MnO₂.

In another embodiment, the invention provides an article of manufacture comprising SiO₂, Al₂O₃, CaO, Fe₂O₃, TiO₂, MgO, Na₂O, Li₂O, CeO₂, ZrO₂, K₂O, P₂O₅, Cr₂O₃, ZnO and MnO₂.

In another embodiment, the invention provides a poly-crystalline product comprising an amount of SiO₂, Al₂O₃, CaO, Fe₂O₃, TiO₂, MgO, Na₂O, Li₂O, CeO₂, ZrO₂, K₂O, P₂O₅, Cr₂O₃, ZnO and MnO₂.

In another embodiment, the invention provides a poly-crystalline product that is produced by a process comprising the steps of: a mixing coal ash particle with at least one glass forming agent and at least one crystallization catalyst; b. melting the coal ash particle, the at least one glass forming agent and the at least one crystallization catalyst to form a mixture; and c. cooling the resulting mixture to ambient temperature to form a homogenous, non-porous microcrystalline composition comprising SiO₂, Al₂O₃, CaO, Fe₂O₃, TiO₂, MgO, Na₂O, Li₂O, CeO₂, Zr, K₂O, P₂O₅, Cr₂O₃, ZnO and MnO₂.

The invention provides a poly-crystalline composition, poly-crystalline product and an article of manufacture which father comprising an amount of 35.0-43.0 percent of SiO₂, 29.0-36.0 percent of Al₂O₃, 1.4-4.1 percent of Fe₂O₃, 16.0-21.0 percent of CaO, 1.3-15.2 percent of TiO₂, 0.6-8.9 percent of K₂O, 1.4-6.8 percent of P₂O₅, 0-6.0 percent of Cr₂O₃, 0-11.2 percent of ZnO, 0-1.5 percent of MnO₂, 0-10.0 percent of MgO, 0-10.2 percent of Na₂O, 0-5.0 percent of CeO₂, 0-5.0 percent of ZrO₂ and 0-10.2 percent of Li₂O by weight.

In another embodiment the invention provides a poly-crystalline composition, poly-crystalline product and an article of manufacture which further comprising an amount of 35.0-57.0 percent of SiO₂, 15.0-36.0 percent of Al₂O₃, 1.4-10.0 percent of Fe₂O₃, 15.0-22.0 percent of CaO, 0.6-15.2 percent of TiO₂, 0.3-11.0 percent of K₂O, 1.4-6.8 percent of P₂O₅, 0-6.0 percent of Cr₂O₃, 0-11.2 percent of ZnO, 0-11.5 percent of MnO₂, 0-10.0 percent of MgO, 0-10.2 percent of Na₂O, 0-5.0 percent of Ce, 0-5.0 percent of ZrO₂ and 0-10.2 percent of Li₂O by weight.

In another embodiment, in step c, the microcrystalline composition further comprising an amount of 35.0-43.0 percent of SiO₂, 29.0-36.0 percent of Al₂O₃, 1.4-4.1 percent of Fe₂O₃, 16.0-21.0 percent of CaO, 1.3-15.2 percent of TiO₂, 0.6-8.9 percent of K₂O, 1.4-6.8 percent of P₂O₅, 0-6.0 percent of Cr₂O₃, 0-11.2 percent of ZnO, 0-1.5 percent of MnO₂, 0-10.0 percent of MgO, 0-10.2 percent of Na₂O, 0-5.0 percent of Ce, 0-5.0 percent of ZrO₂ and 0-10.2 percent of Li₂O by weight.

In another embodiment, in step C, the microcrystalline composition further comprising an amount of 35.0-57.0 percent of SiO₂, 15.0-36.0 percent of Al₂O₃, 1.4-10.0 percent of Fe₂O₃, 15.0-22.0 percent of CaO, 0.6-15.2 percent of TiO₂, 0.3-11.0 percent of K₂O, 1.4-6.8 percent of P₂O₅, 0-6.0 percent of Cr₂O₃, 0-11.2 percent of ZnO, 0-11.5 percent of MnO₂, 0-10.0 percent of MgO, 0-10.2 percent of Na₂O, 0-5.0 percent of CeO₂, 0-5.0 percent of ZrO₂ and 0-10.2 percent of Li₂O by weight.

According to the teachings of the present invention there is provided a method for producing a crystalline material comprising: a) providing ash; b) melting the ash so as to form a molten mixture; and c) devitrfying the molten mixture so as to produce the crystalline material wherein the molten mixture includes between about 25.0% and about 57.0% by weight SiO₂; between about 29.0% and about 45.0% by weight Al₂O₃; between about 0.3% and about 10% by weight Fe₂O₃; between about 5.4% and about 34.0% by weight CaO; between about 0.6% and about 24.0% by weight TiO₂; between about 0.2% and about 15.0% by weight K₂O; and between about 0.3% and about 13.0% by weight P₂O₅. Suitable ashes include fly ash, bottom ash, coal ash, municipal incinerator ash and combinations thereof. In embodiments of the present invention, the ash comprises a combination of ashes from difference sources.

In embodiments of the present invention, prior to (b), the ash is heated at a temperature for a period of time so as to remove residual carbon, e.g., to a temperature of between about 650° C. and about 700° C., e.g., for a period of time between about 2 and about 10 hours.

In embodiments of the present invention, prior to (c), at least one glass-forming agent is added so as to be a component of the molten mixture. Suitable glass-forming agents include but are not limited to SiO₂, Al₂O₃, Li₂O, MgO, Na₂O, CaO and K₂O.

In embodiments of the present invention, prior to (c), at least one crystallization catalyst is added so as to be a component of the molten mixture. Suitable crystallization catalysts include but are not limited to TiO₂, Cr₂O₃, ZnO, CeO₂, MnO₂, and ZrO₂.

In embodiments of the present invention, prior to (c), at least one additional substance is added as component of the molten mixture, the at least one additional substance selected from the group consisting of CaCO₃, Al₂O₃, technical Al₂O₃, magnesium salts, calcium salts, lithium salts, SiO₂, CaO, Na₂O, Cr₂O₃.

In embodiments of the present invention the molten mixture includes at least about 35.0% by weight SiO₂.

In embodiments of the present invention the molten mixture includes less than about 50.0% by weight SiO₂.

In embodiments of the present invention the molten mixture includes at least about 30.0% by weight Al₂O₃.

In embodiments of the present invention the molten mixture includes less than about 36.0% by weight Al₂O₃.

In embodiments of the present invention the molten mixture includes at least about 1.4% by weight Fe₂O₃.

In embodiments of the present invention the molten mixture includes less than about 6.0% by weight Fe₂O₃.

In embodiments of the present invention the molten mixture includes at least about 10.0% by weight CaO.

In embodiments of the present invention the molten mixture includes less than about 30.0% by weight CaO.

In embodiments of the present invention the molten mixture includes at least about 1.3% by weight TiO₂.

In embodiments of the present invention the molten mixture includes less than about 15.2% by weight TiO₂.

In embodiments of the present invention the molten mixture includes at least about 0.3% by weight K₂O.

In embodiments of the present invention the molten mixture includes less than about 11% by weight K₂O.

In embodiments of the present invention the molten mixture includes at least about 1.4% by weight P₂O₅.

In embodiments of the present invention the molten mixture includes less than about 6.8% by weight P₂O₅.

According to the teachings of the present invention there is also provided a method for producing a crystalline material comprising: a) providing ash; b) melting the ash so as to form a molten mixture; and c) devitrifying the molten mixture so as to produce the crystalline material wherein the molten mixture consists essentially of group II oxides, group III oxides, group IV oxides, group V oxides and lanthanoid oxides, and wherein the molten mixture includes between about 25.0% and about 57.0% by Weight SiO₂; between about 24.0% and about 45.0% by weight Al₂O₃; between about 0.3% and about 10% by weight Fe₂O₃; between about 5.4% and about 34.0% by weight CaO; between about 0.6% and about 24-0% by weight TiO₂; between about 0.2% and about 15.0% by weight K₂O; and between about 0.3% and about 13.0% by weight P₂O₅ and is substantially devoid of ZnO.

According to the teachings of the present invention there is also provided a method for producing a crystalline material comprising: a) providing ash; b) melting the ash so as to form a molten mixture; and c) devitrifying the molten mixture so as to produce the crystalline material wherein the molten mixture includes between about 25.0% and about 57.0% by weight SiO₂; between about 24.0% and about 45.0% by weight Al₂O₃; between about 0.3% and about 10% by weight Fe₂O₃, between about 28% and about 34.0% by weight CaO; between about 0.6% and about 24.0% by weight TiO₂; between about 0.2% and about 15.0% by weight K₂O; and between about 0.3% and about 13.0% by weight P₂O₅. In embodiments of the present invention, devitrification of a molten mixture to form a crystalline product is performed under a one-stage or a two-stage crystallization regime. Preferably, devitrification is performed in accordance with the crystallization regime of the present invention (vide infra).

Generally, devitrification involves maintaining a molten glass composition within an appropriate temperature range for a period of time sufficient to allow crystallization of at least some of the molten glass composition.

In embodiments of the present invention, the devitrification includes maintaining the glass composition within a relatively narrow temperature range for a period of time sufficient to allow crystallization of at least some of the glass composition, that is, a one-stage crystallization regime.

In embodiments of the present invention, the molten glass mixture is contained in a mold inside a chamber of a furnace provided with a heating controller that is configured to control the rate of heating of the chamber and the devitrification of the molten glass mixture includes the steps of: i) using the heating controller to reduce the temperature of the chamber to a second temperature T2 so as to allow formation of nucleation centers in the molten glass mixture; ii) using the heating controller to increase the chamber temperature from the second temperature T2 to a third temperature T3 at a first rate; iii) using the heating controller to increase the chamber temperature from the third temperature T3 to a fourth temperature T4 at a second rate; and iv) allowing the glass mixture to crystallize, yielding the crystalline material.

In embodiments of the present invention, the second temperature T2 is between about 650° C. and about 750° C. In embodiments of the present invention the fourth temperature T4 is between about 900° C. and about 1000° C.

In embodiments of the present invention, subsequent to (i) the heating controller is used to maintain the chamber temperature at the temperature T4 for a period of time sufficient to allow the formation of more nucleation centers in the molten glass mixture. The formation of more or less nucleation centers often influences physical properties of materials fashioned according to the teachings of the present invention.

In embodiments of the present invention, the chamber temperature is increased beyond the fourth temperature T4 for crystallization. In embodiments of the present invention, once the fourth temperature T4 is attained the chamber temperature is allowed to cool either because a sufficient degree of crystallization has been attained or because sufficient crystallization occurs during the cooling process. In embodiments of the present invention, subsequent to (iii) the heating controller is used to maintain the chamber temperature at least at the fourth temperature T4 for a period of time sufficient to allow the crystallization of the glass composition. A greater or lesser extent of crystallization often influences physical properties of materials fashioned according to the teachings of the present invention.

In embodiments of the present invention, the increase from the second temperature T2 to the third temperature T3 is monotonic, that is the heating controller is set to increase the temperature between T2 and T3 at a constant first rate.

In embodiments of the present invention, the increase from the second temperature T3 to the third temperature T4 is monotonic, that is the heating controller is set to increase the temperature between T3 and T4 at a constant second rate.

In embodiments of the present invention, the first rate and the second rate of temperature increase are substantially equal, that is a two-stage crystallization regime.

In embodiments of the present invention, the second rate is substantially lower than the first rate, that is the crystallization regime of the present invention.

In embodiments of the present invention, the first rate is between about 10° C. h⁻¹ and about 60° C. h⁻¹, or between about 20° C. h⁻¹ and about 40° C. h⁻¹.

In embodiments of the present invention, the second rate is between about 2° C. h⁻¹ and about 15° C. h⁻¹, or between about 3° C. h⁻¹ and about 10° C. h⁻¹.

In embodiments of the present invention, the first rate is at least twice the second rate, at least three times greater than the second rate and even at least four times greater than the second rate.

The crystallization regime of the present invention is applicable for the manufacture of many different crystalline products. Thus according to the teachings of the present invention there is also provided a method for the manufacture of a crystalline object, comprising: a) providing a furnace (e.g., a gas-fired furnace) comprising at least one chamber, within the chamber a mold containing a substrate (e.g., a glass composition), and a heating controller configured to control the rate of heating the chamber, b) using the heating controller to raise the temperature of the chamber to a first temperature T1 so as to melt the substrate (forming a molten substrate); c) using the heating controller to reduce the temperature of the chamber to a second temperature T2 so as to allow formation of nucleation centers in the molten substrate; d) using the heating controller to increase the chamber temperature from the second temperature T2 to a third temperature T3 at a first rate; e) using the heating controller to increase the chamber temperature from the third temperature T3 to a fourth temperature T4 at a second rate; and f) allowing the substrate to crystallize, yielding the crystalline object wherein the second rate is substantially lower than the first rate.

In embodiments of the present invention, subsequent to (c) the heating controller is used to maintain the chamber temperature at the temperature T2 for a period of time sufficient to allow the formation of more nucleation centers in the substrate. The formation of more or less nucleation centers often influences physical properties of a crystalline object manufactured according to the teachings of the present invention.

In embodiments of the present invention, the chamber temperature is increased beyond the fourth temperature T4 for crystallization. In embodiments of the present invention, once the fourth temperature T4 is attained the chamber temperature is allowed to cool either because a sufficient degree of crystallization has been attained or because sufficient crystallization occurs during the cooling process. In embodiments of the present invention, subsequent to (e) the heating controller is used to maintain the chamber temperature at least at the fourth temperature T4 for a period of time sufficient to allow the crystallization of the substrate. A greater or lesser extent of crystallization often influences physical properties of crystalline objects manufactured according to the teachings of the present invention.

In embodiments of the present invention, the increase from the second temperature T2 to the third temperature T3 is monotonic, that is the heating controller is set to increase the temperature between T2 and T3 at a constant first rate.

In embodiments of the present invention, the increase from the second temperature T3 to the third temperature T4 is monotonic, that is the heating controller is set to increase the temperature between T3 and T4 at a constant second rate.

In embodiments of the present invention, the first rate is between about 10° C. h⁻¹ and about 60° C. h⁻¹, or between about 20° C. h⁻¹ and about 40° C. h⁻¹.

In embodiments of the present invention, the second rate is between about 2° C. h⁻¹ and about 15° C. h⁻¹, or between about 3° C. h⁻¹ and about 10° C. h⁻¹.

In embodiments of the present invention, the first rate is at least twice the second rate, at least three times greater than the second rate and even at least four Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 (prior art) is a graph showing the relationship between temperature and the nucleation center formation rate (dashed) and the crystallization rate (solid);

FIG. 2 depicts a furnace useful in implementing the crystallization regime of the present invention; and

FIG. 3 is a graph showing the temperature setting (in ° C.) as a function of time (in hours) of a temperature controller implementing the crystallization regime of the present invention.

### DESCRIPTION OF THE PREFERRED EMBODIMENTS

The present invention is of methods for producing and manufacturing glass-ceramics and other crystalline materials (solid materials that include at least one crystal phase).

As used herein, the term “process” and the term “method” refers to manners, means, techniques and procedures for accomplishing a given task including, but not limited to, those manners, means, techniques and procedures either known to, or readily developed from known manners, means, techniques and procedures by practitioners of the chemical, material science, defense and ceramic arts.

The principles and uses of the processes, compositions and methods of the present invention may be better understood with reference to the description, figures and examples hereinbelow.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

The present invention provides for obtaining and using coal ash for the production of poly-crystalline compositions or products and in another aspect the invention provides processes for producing the same. The invention is particularly applicable to coal ash that contains large amounts of calcium oxide and transition metals such as iron manganese, chromium, titanium and the like.

Herein the term “bottom ash” or “bottom coal ash” is used as is known in the art and refers to relatively large (0.2-10 millimeters) ash particles that are not carried away by smoke and other exhaust gases and rather accumulate at the bottom of the furnace.

Herein the term “fly ash” or “fly coal ash” is used as is known in the art and refers to fine (5-50 μm) ash particles that are carried away by smoke, draft or exhaust gases and accumulate in flues or are trapped in filters, precipitators and the like. The coal ash contains organic materials and metal contaminants.

Herein the term ash or coal ash refer collectively to both fly ash and to bottom ash, unless one of them is stated particularly. As is exemplified in Example 6, both fly ash and bottom ash can be used to prepare the composition and articles of the invention.

In one embodiment of the present invention, there is provided a poly-crystalline composition, a poly-crystalline product and an article of manufacture comprising oxides such as SiO₂, Al₂O₃, CaO, Fe₂O₃, TiO₂, K₂O, P₂O₅, Cr₂O₃, ZnO, MgO, ZrO₂ and MnO₂.

The poly-crystalline products are poly-crystalline materials obtained from special glass compositions by means of catalysis crystallization and consisting from one to several crystalline mineralogical phases, uniformly distributed in the remaining glass phase. As used here in the specifications and in the claims section the term “catalysts for crystallization” refer to substances that serve as a nuclei of crystallization, such as without being limited, titanium dioxide, chromium oxide, zinc oxide, cerium dioxide manganese dioxide, and zirconium dioxide. Changing of the starting glass composition, by changing the glass forming agents or the catalyst type and quality, or the heating or cooling parameters results in glass ceramic materials with predetermined mineralogical compositions and chemical, mechanical and thermal properties.

In another embodiment of the present invention there is provided a process for producing a poly-crystalline product. The process comprises the following steps; mixing coal ash particles with at least one glass forming agent and at least one crystallization catalyst, in a mechanical blender or a pneumatic blender; b. heating in furnaces in temperature in the range of 1400° C. to 1600° C. and melting the mixture of the coal ash particles, the at least one glass forming agent and the at least one crystallization catalyst to form a mixture. This step can be carried out in a bath, pot, open hearth or electric melters; and c. cooling the resulting mixture to ambient temperature to form a homogenous, non-porous poly-crystalline product comprising SiO₂, Al₂O₃, CaO, Fe₂O₃, TiO₂, K₂O, P₂O₅, Cr₂O₃, ZnO, MgO, Na₂O, Li₂O, CeO₂, ZrO₂ and MnO₂. It should be noted in this respect that the heating, melting and cooling steps are carried out under methods and by using apparatuses that are known in the art.

The parameters of the heating and cooling are determined by type of manufactured product and are easy to perform by anyone who is skilled in the art. The cooling step can be an immediate step or a gradual step. Further examples are provided in U.S. Pat. No. 5,935,885.

In another embodiment, the at least one glass forming agent is selected from the following oxides group: SiO₂, Al₂O₃, Li₂O, MgO, Na₂O, CaO and K₂O. Thus, different compositions and different amounts of the glass forming agents provide products with different colors and different textures that contain metallic contaminants. As used herein the term “texture” refer to the smoothness, or the evenness or the uniformity or the glossiness of the product which may be glossy, silky, or polished surface or roughly, unsmooth, bristly, unpolished, metallic, wrinkled leather surface or a granulated surface. The colors of the products can be without being limited black, light and dark green, brown, gray, silver and bronze. The color and the texture of the poly crystalline are affected by factors like the compositions and the ratio of the different glass forming agents, the crystallization catalysts, the heating temperature, the rate of cooling as well as the atmosphere in the furnace.

In another embodiment of the present intention, the crystallization catalysts are selected from the group consisting of TiO₂, Cr₂O₃, ZnO, CeO₂, MnO₂, and ZrO₂. The poly-crystalline composition according to the present invention further comprising by weight, 35.0-43.0 percent of SiO₂, 29.0-36.0 percent of Al₂O₃, 1.4-4.1 percent of FeO₃, 16.0-21.0 percent of CaO, 1.3-15.2 percent of TiO₂, 0.6-8.9 percent of K₂O, 1.4-6.8 percent of P₂O₅, 0-6.0 percent of Cr₂O₃, 0-11.2 percent of ZnO, 0-1.5 percent of MnO₂, 0-10.0 percent of MgO, 0-10.2 percent of Na₂O, 0-5.0 percent of CeO₂, 0-5.0 percent of ZrO₂ and 0-10.2 percent of Li₂O.

In another embodiment, the poly-crystalline composition further comprising by weight of 35.0-57.0 percent of SiO₂, 15.0-36.0 percent of Al₂O₃, 1.4-10.0 percent of Fe₂O₃, 15.0-22.0 percent of CaO, 0.6-15.2 percent of TiO₂, 0.3-11.0 percent of K₂O, 1.4-6.8 percent of P₂O₅, 0-6.0 percent of Cr₂O₃, 0-11.2 percent of ZnO, 0-11.5 percent of MnO₂, 0-10.0 percent of MgO, 0-10.2 percent of Na₂O, 0-5.0 percent of CeO₂, 0-5.0 percent of ZrO₂ and 0-10.2 percent of Li₂O by weight

In another embodiment of the present invention, the crystallization catalysts are selected from the group consisting of TiO₂, Cr₂O₃, ZnO, CeO₂, MnO₂, and ZrO₂. The poly-crystalline composition according to the present invention further comprising by weight, 25.0-50.0 percent of SiO₂, 20.0-45.0 percent of Al₂O₃, 0.36 percent of Fe₂O₃, 10-30.0 percent of CaO, 0.3-24.0 percent of TiO₂, 0.2-15 percent of K₂O, 0.3-13 percent of P₂O₅, 0-6 percent of Cr₂O₃, 0-20 percent of ZnO, 0-6 percent of Mn₂, 0-19.0 percent of MgO, 0-19.0 percent of Na₂O, 0-9.0 percent of CeO₂, 0-9.0 percent of ZrO₂ and 0-19.0 percent of Li₂O.

The invented utilization of coal ash for obtaining glass-crystalline materials, (glass-ceramics) provides an example for a technical solution, which utilizes considerable quantities of coal ash for obtaining a new class of materials with improved physical and decoration characteristics in comparison to other materials which currently exist in the market.

Different physical characteristics, such as for example, strength, hardness, thermal resistant and wear resistance distinguish the product and the composition of the present invention from other products and compositions that were described before. As is exemplified in the examples section, there is provided an embodiment of changing the product physical characteristics by adding different glass forming agent, and by changing the heating and cooling conditions. Thus, it is possible to provide a product which will suit the applications requirements.

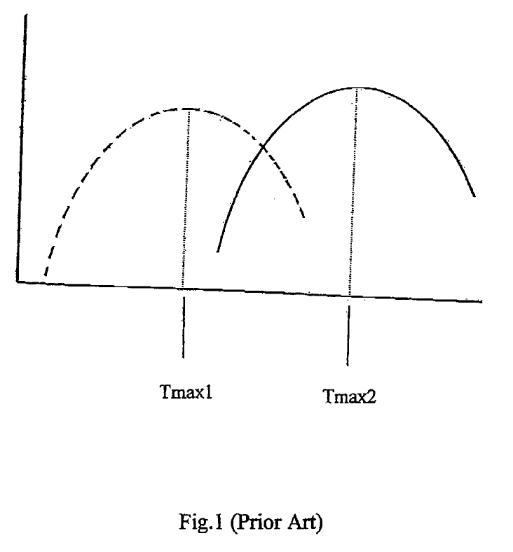

The crystal size and crystal content in a glass-ceramic material is dependent on at least two production parameters: the rate of formation of nucleation centers (which occurs at a maximal rate at some temperature Tₘₐₓ₁) and the rate of crystal growth (which occurs at a maximal rate at some temperature Tₘₐₓ₂, where Tₘₐₓ₂>Tₘₐₓ₁), see FIG. 1. Ideally, once Tₘₐₓ₁ and Tₘₐₓ₂ are known, a crystallization regime can be formulated The problem is that Tₘₐₓ₁ and Tₘₐₓ₂ are dependent on many factors, are not predictable and fluctuate depending on many conditions.

Generally, when a new glass-ceramic composition is formulated, preferred furnace conditions such as temperatures Tₘₐₓ₁ and Tₘₐₓ₂, rates of heating are determined using a small-scale furnace holding a single or a few workpieces at any one time. In subsequent scale-up to a furnace used for simultaneously manufacturing many glass-ceramic workpieces, under conditions which are identical or similar to those optimized using the small-scale furnaces, a very high percentage of workpieces are rejected. These include workpieces that are cracked or have improperly crystallized, such that the physical properties are unsuitable for the intended use. This is a result of the fact that temperature, heat transfer and heating rate in a furnace chamber are spatially inhomogeneous, especially for large-volume production furnaces chambers filled with many work-pieces.

As a compromise, in the art it is known to use either a one-stage crystallization regime or a two-stage crystallization regime.

In a one-stage crystallization regime, a molten substrate is maintained at a single temperature midway between Tₘₐₓ₁ and Tₘₐₓ₂, the single temperature giving an acceptable compromise of properties.

In a two-stage crystallization regime, a molten substrate is maintained at a first temperature, the first temperature being roughly Tₘₐₓ₁. After a certain amount of time deemed sufficient for formation of enough nucleation centers, the temperature of the substrate is raised to a second higher temperature, the second temperature being roughly Tₘₐₓ₂.

The one-stage and two-stage crystallization regimes generally provide a reasonable percentage of rejected workpieces. That said, it is generally preferable to reduce the percentage of rejected workpieces even further. Further, the batch to batch reproducibility of one-stage and two-stage crystallization regimes is low, with the percentage of rejected workpieces varying greatly as a result of varying ambient temperature, pressure and humidity. Further, for certain glass-ceramic substrates it is very difficult if not impossible to find parameters for either the one-stage or two-stage crystallization regimes giving a reasonable percentage of rejected workpieces.

It has been found that it is possible to achieve a very low percentage of rejected workpieces with a very high batch-to-batch reproducibility when using the crystallization regime of the present invention. It is believed that the applicability of the crystallization regime is not limited to the devitrification of glass compositions to yield glass-ceramics but is generally applicable to the manufacture of crystalline objects from molten substrates.

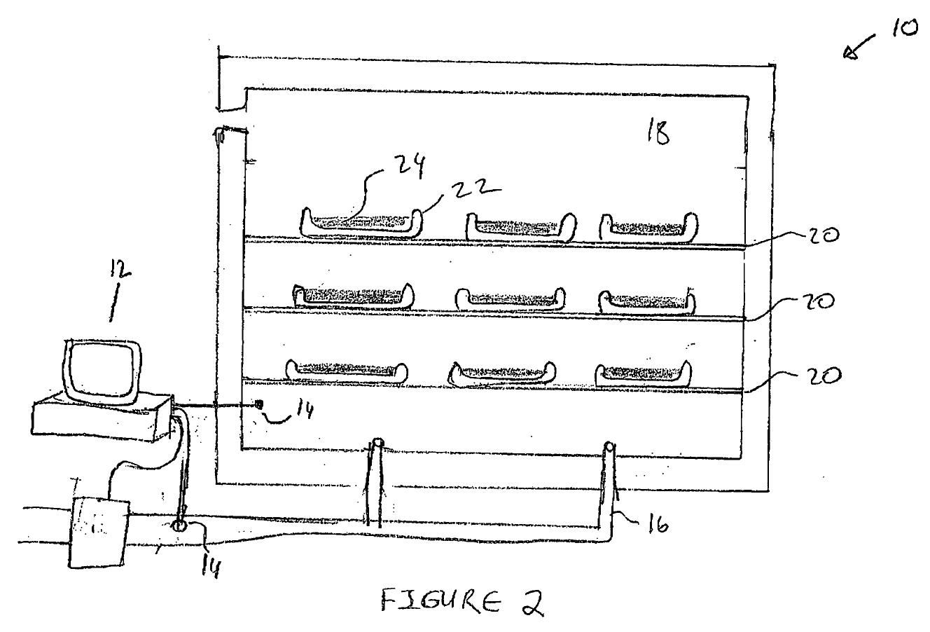

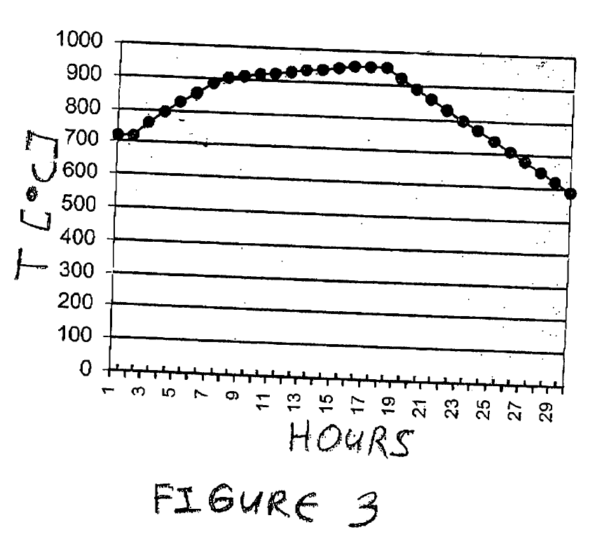

The crystallization regime of the present invention can be understood with reference to FIG. 2 and FIG. 3. In FIG. 2 a furnace 10 is provided with a heating controller 12 in communication with temperature sensors 14 and a heating device 16 (in FIG. 2, a gas heating system). Inside a chamber 18 of furnace 10 are three racks 20. On each rack 20 are found three molds 22 containing a molten substrate 24. In FIG. 3, an example of the temperature setting of heating controller 12 as a function of time is graphically depicted.

Heating controller 12 is used to raise the temperature inside chamber 18 to a first temperature T1 high enough so as to melt substrate 24.

Heating controller 12 is then used to reduce the temperature in chamber 18 to a second temperature T2 so as to allow formation of nucleation centers in molten substrate 24. Generally, but not necessarily, T2 is roughly equal to or somewhat lower than Tₘₐₓ₁ Of substrate 24. In FIG. 3, it is seen that from hour 1 to hour 2 heating controller 12 is set to maintain the temperature of chamber 18 at 725° C.

Heating controller 12 is then used to increase the chamber temperature from the second temperature T2 to a third temperature T3 at a first rate and subsequently from the third temperature T3 to a fourth temperature T4 at a second rate where the second rate is substantially slower than the first rate during which time the rate of nucleation center formation gradually decreases but the rate of crystallization increases. In embodiments of the present invention, the first rate is at least twice the second rate, at least three times greater than the second rate and even at least four times greater than the second rate. Generally, but not necessarily, T4 is roughly equal to or somewhat higher than T, of substrate 24. In FIG. 3 it is seen that from hour 2 to hour 8 heating controller is set to increase the chamber temperature from the second temperature T2 (725° C.) to a third temperature T3 (900° C.) at a first rate (29° C. hour⁻¹) and from hour 8 to hour 18 to increase the chamber temperature from third temperature T3 to fourth temperature T4 (950° C.) at second rate (6.25° C. hour 1).

Although not necessary, it is often advantageous to maintain chamber 18 at approximately second temperature T2 for a period of time as depicted in FIG. 3 (hour 1 to hour 2) to allow the formation of more nucleation centers in substrate 24. The formation of more or less nucleation centers often influences physical properties of a crystalline object manufactured according to the teachings of the present invention.

In embodiments of the present invention, the chamber temperature is increased beyond the fourth temperature T4 allowing further crystallization. In embodiments of the present invention, once the fourth temperature T4 is attained the chamber temperature is allowed to cool as depicted in FIG. 3, either because a sufficient degree of crystallization has been attained or because sufficient crystallization occurs during the cooling. In embodiments of the present invention, it is often advantageous to maintain chamber 18 about at fourth temperature T4 to allow crystallization of substrate 24. A greater or lesser extent of crystallization often influences physical properties of crystalline objects manufactured according to the teachings of the present invention.

Preferably but not necessarily, the increase from the second temperature T2 to the third temperature T3 is monotonic, that is heating controller 12 is set to increase the temperature between T2 and T3 at a constant first rate as depicted in FIG. 3.

Preferably but not necessarily, the increase from the third temperature T3 to the fourth temperature T4 is monotonic, that is heating controller 12 is set to increase the temperature between T3 and T4 at a constant second rate as depicted in FIG. 3. In embodiments of the present invention, the first rate is between about 10° C. h⁻¹ and about 60° C. h⁻¹, or between about 20° C. h⁻¹ and about 40° C. h⁻¹. In embodiments of the present invention, the second rate is between about 2° C. h⁻¹ and about 15° C. h⁻¹, or between about 3° C., h⁻¹ and about 10° C. h⁻¹. Such rates have been found useful for manufacturing glass-ceramics, especially Anorthite containing glass-ceramics described herein.

It is important to note that although the crystallization regime of the present invention described above and in FIG. 3 includes only two rates of temperature increase between T2 and T4, embodiments of the present invention are countenanced having three rates, four rates and even more rates, including a continuously varying rate. Thus, the crystallization regime of the present invention is characterized amongst other characteristics, that during a stage of the crystallization where the furnace

In one embodiment, there is provided a non-porous poly-crystalline composition. In another embodiment the porosity index is in the range of 0.3-0.7% and is about 0.5%. Thus, the invention provides compositions and products that have no water absorption are gas impermeable and also have low thermal conductivity.

In another embodiment the density of the poly-crystalline composition is in the range of 2.5*10³ to 2.9*10³ kg m⁻³.

The product and composition have strong thermal resistance, whereas in one embodiment, the initial temperature of softening is about 1200° C.

As used herein in the specification and in the claims section below the term “about” refers to ±20%

As is exemplified in the Examples, the present invention compositions and products have a similar stochiometric ratio to poly crystalline structures that exist in nature. These are for example, without being limited, anorthite crystals, cordierite crystals, wollastonite crystals, lithium disilicate crystals and chromium oxide crystals.

The described process of production enables to manufacture glass-ceramic facing plates, which are of uniform quality.

Assessment of the products that were produced according to the processes and the starting materials described in the Examples show the following:

These materials are better than the building ceramic concerning the porosity index (˜0.5%) but much lower than the practically un-porous glass ceramics (porosity <0.02%). Thermal Coefficient of Linear Expansion (TCLE) is changed within relatively narrow limits (80−100)*10⁻⁷ ° C.⁻¹ that corresponds to the building ceramic, whereas for the usual glass ceramics the range of this parameter is wider from 20 to 120*10⁻⁷ ° C.^{-1.}

Careful assessment of the materials microstructure by electron microscope (Holon Academic Astute of Technology, Israel) showed dense glass ceramic structure with crystal dimensions ˜1 mkm. Determination of the mineralogical composition the products of Example 1 by X-ray diffraction (The Ministry of National Infrastructures, Geological Survey, Israel) revealed that the predominant crystalline phase is anorthite whereas the additional crystalline phase is albite.

The Thermal Coefficient of Linear Expansion (TCLE) of the glass ceramics (assessed by Israeli Institute of Ceramic and Silicates, Ben-Gurion University of Negev, Israel) was found to be up to 52*10⁻⁷ ° C.⁻¹. The glass density was found to be up to 2.72*10³ kg m⁻³; the porosity less than 0.02%; bending strength was up to 150 MPa; temperature strength under load was 1100° C. Other mechanical characteristics were performed in Holon Academic Institute of Technology, Israel: micro-hardness HV (Vickers) up to 8.2 GPa, wear resistance five times more than the customary building ceramic. Adhesion in the stick on to the concretc (Standard Institute of Israel) was 1.5-4.0 times (in dependence on the glue) more than the standard requirements. Discharge of radon Rn²²² was lower than the sensitivity level of the control-measuring instruments (Nahal Soreq Nuclear Center, Israel). The level of radioactive emission of the product (Nabal Sorcq Nuclear Center, Ministry of the Environment, Radiation Safety Division, Israel) was 22-fold less than the pernissible level. The glass ceramics products were found to be water-resistant and were stable to acids and alkali effects.

The proposed glass ceramics correspond to ° C. of tungsten (TCLE of tungsten 43*10⁻⁷ ° C.⁻¹ is substantially similar to the TCLE of glass ceramic materials of the present invention). It allows introducing them in tungsten fast elements needed in cases when usual sticking is not possible or is dangerous.

Thus, the present invention is directed to an efficient process of utilization of coal ash, which result from municipal waste. The resulting products and compositions are of a high quality, nice and interesting appearance and colors, and have superior physical properties such as compressive strength, bending strength, impact strength, and low thermal conductivity.

Moreover, the process of the present invention is a low cost process that does not required additional preparation (such as grinding, purification, concentration and the like).

As is exemplified in the Examples below, the invention provides methods for producing glass ceramics and marble-like glasses, which are made from fly coal ash as well as bottom ash from any part of the world Example 1-6 relates to coal ash obtained from South Africa, whereas Example 7 and 8 relates respectively to coal ash obtained from USA to a mixed coal derived from Australia and Asia.

By practicing the inventive process and products, ready to use products are provided such as, for example without limitation, articles for house construction, granite, ceramic riles for internal or external walls and for floor lining. Also, the developed products can be widely used in civil- and industry engineering for lining of different chutes, tubes, boxes, trays, bins and trestles in the food, chemical, mining and other industry fastening elements, coatings, high-voltage insulators, hermetic containers for storage of radioactive waste, parts of pumps, heat exchangers, heat resistant parts, corrosion resistant parts, as antiballistic and the rest.

It will be appreciated that the present invention is not limited by what has been described hereinabove and that numerous modifications, all of which fall within the scope of the present invention, exist. For example, while the present invention has been described with respect to the Examples section, which provides the above described compositions, it will be appreciated by persons skilled in the art that the present invention is not limited by what has been particularly shown and described herein above. It is to be understood that other close compositions and agents comprising other ratios and other components can be effectively employed in the present invention process, products and compositions.

### EXAMPLES

Reference is now made to the following example that, together with the above description, illustrate the invention in a non-limiting fashion

The present invention relates to the production of glass ceramics and marble-like glasses from coal ash. In all of the following examples different compositions of coal ash were mixed with glass-forming agents such as for example SiO₂, Al₂O₃, Li₂O, MgO, Na₂O, CaO, K₂O and catalysts of crystallization such as TiO₂, Cr₂O₃, ZnO, CeO₂, MnO₂ and ZrO₂. The substances were than heated and melted in furnaces and than cooled to ambient temperature. The different compositions of the glass forming agents, the different catalysts of crystallization and different heating and cooling conditions resulted in different colors and different textures of the glass products.

The process of the glass, manufacturing included the step of heating the materials in furnaces: at the preliminary stage (before mixing with other glass-forming materials) the coal ash was thermally heated at a temperature in the range of 650-700° C. for 2-10 hours for burning-out coal (carbon) remainders that might influence the furnace atmosphere; exposure to the same temperature in the heat process during the glass cooking (after mixing the ash with the other raw materials) provides additional regulation of the furnace atmosphere through incorporation of raw materials in the form of salts that discharge the furnace atmosphere with gases. The atmosphere is also changed by replacing carbonates by nitrates or by a direct introduction of gases (oxygen, nitrogen, carbon dioxide) to the furnace atmosphere.

### Materials, Instruments and Experimental Methods

In the following examples, all glass ceramics of the present invention were prepared using Ash I and Ash II having the following compositions in weight percents:

TABLE 1

| Component | *Coal ash I (South Africa) | *Coal ash II (South Africa) |
|---|---|---|
| SiO₂ | 44.9 | 46.0 |
| Al₂O₃ | 32.3 | 32.4 |
| Fe₂O₃ | 4.5 | 1.8 |
| CaO | 6.9 | 11.2 |
| TiO₂ | 1.9 | 1.8 |
| K₂O | 0.8 | 0.8 |
| P₂O₅ | 3.1 | 1.9 |
| Coal | 5.6 | 4.1 |

*coal ash I and coal ash II stand for different samples taken from ash coal.

### Example 1

### Production of Anorthite Glass Ceramic on the Basis of Fly Coal Ash

The following process was used to produce an anorthite glass ceramic product: Anorthite (which is composed mainly of CaO* A₂O₃ *2 SiO₂) is related to a class of silicate of the frame structure type. The density of crystals is (2.74-2.76)*10³ kg m⁻³; the melting temperature is 1550° C.; TCLE is 40*10⁻⁷ ° C.⁻¹; the dielectric constant is 6.9 and the hardness (Mohs scale) is 6.0-6.5.

Ashes I and II were used (see Table 1). The stochiometric mass ratio of the oxides CaO, Al₂O₃ and SiO₂ in the anorthite is 1.0:1.8:2.1 respectively. The resulting stochiometry of the product made with ash I was found to be 1.0:4.7:6.5 and with ash II 1.0:2.9:4.1, respectively. Thus, in order to improve the composition, calcium carbonate (CaCO₃) and technical alumina (Al₂O₃) were added. The catalysts of crystallization that were used in this process were TiO₂, Cr₂O₃, P₂O₅, followed by administration phosphoric acid potassium. The resulting composition was (mass %): SiO₂ 35.0-43.0; Al₂O₃ 29.0-36.0; Fe₂O₃ 1.4-4.1; CaO 16.0-21.0; TiO₂ 1.3-15.2; K₂O 0.6-8.9; P₂O₅ 1.4-6.8; Cr₂O₃ 0-1.5, ZnO 0-112, MnO₂ 0-1.5.

Glass cooking was carried out in an electrical furnace al 1480-1550° C. in quartz or alumina crucibles.

The following glass products were obtained: a. colored glass ceramics of black, light- and dark-green, dark- and light gray colors with a shining frosted surface; b. colored marble-like glasses of intensive black, light- and dark-green, light- and dark-brown colors with decorative surface patterns; and c. glass ceramics with different surfaces e.g. “metallic” surface, “wrinkled leather” effect and an uneven painting which has a light colors in the center that becomes gradually darker on the outlying area

### Example 2

### Production of Cordierite Glass Ceramic on the Basis of Fly Coal Ash

The following process was used to produce a cordierite glass ceramic on the basis of fly coal ash. Cordierite (which is composed mainly of 2MgO*2Al₂O₃*5SiO₂) relates to a class silicates of circular structure type. The crystals density is 2.53*10³ kg m⁻³, the melting temperature is 1470° C., TCLE is 26*10⁻⁷ ° C.⁻¹, the dielectric constant is 7 and the hardness on the Mohs scale is 7-7.5.

Ashes I and II (see Table 1) were used. The stoichiometric mass ratio of oxides MgO:Al₂O₃:SiO₂ in cordierite is 1.0:2.6:3.8. The ratio of Al₂O₃:SiO₂ in cordierite is 1.0:1.5. The ratio of Al₂O₃:SiO₂ in the ashes I and II approximately corresponds to cordierite without MgO. Thus, for improving the composition, magnesium salts were added. The following catalysts of crystallization were used either separately or in combinations: titanium dioxide, chromium oxide and zinc oxide. The resulting composition was (mass %):
SiO₂ 30.0-38.0; Al₂O₃ 20.0-25.0; Fe₂O₃ 1.5-4.4; CaO 6.0-10.0; MgO 8.0-10.0; TiO₂ 1.1-11.2; K₂O 0.6-1.0; P₂O₅ 1.4-3.0; Cr₂O₃ 0-2.0, ZnO 0-9.0.

The products obtained were: a. colored glass ceramics of black the light- and dark brown; b. colors with a shining and non glossy surface; and c. colored marble-like of intensity black color.

### Example 3

### Production of Wollasonite Glass Ceramic on the Basis of Fly Coal Ash

The following process was performed for obtaining of wollastonite glass ceramic on the basis of fly coal ash.

Wollastonite CaO*SiO₂ relates to the silicate class of chain type. The crystals density is 2-928*10³ kg m⁻³; the melt temperature is 1540° C.; TCLE 94*10⁻⁷ ° C.⁻¹; the dielectric constant is 6.2; and the hardness according to Mohs scale is 4.0-4.5.

Ashes I and II (see Table 1) have been used. The stoichiometric mass ratio of oxides CaO:SiO₂ in the wollastonite is 1.0:1.1. The stoichiometric mass ratio of the oxides CaO:SiO₂ Obtained with ash I was 1.0:6.5; and in ash II 1.0:4.1, respectively. Thus, for improving the composition calcium salts were added. The catalysts of crystallization that were used either separately or in combination were titanium dioxide, chromium oxide and zinc oxide. The resulting composition was (mass %): SiO₂ 38.0-43.0; Al₂O₃ 20.0-27.0; Fe₂O₃ 1.3-3.2; CaO 28.0-34.0; TiO₂ 1.1-8.6; K₂O 0.6-1.0; P₂O₅ 1.4-3.0; Cr₂O₃ 0-2.0, ZnO 0

The resulting product was a colored light gray and dark brown glass ceramic with non-glossy surface.

### Example 4

### Production of Glass Ceramic with Lithium Disilicate as the Main Crystalline Phase on the Basis of Fly Coal Ash

Lithium disilicate Li₂O*2SiO₂ relates to a class of silicate. The crystals density is 2,45*103 kg m⁻³, the melting temperature is 1032° C. and TCLE is 110*10⁻⁷ ° C.⁻¹. Ashes I and II were used. For improving the composition lithium salts were added to the ashes. Titanium dioxide TiO₂ and chromium oxide Cr₂O₃ were used as catalysts of crystallization (either separately or in combination). The resulting composition was (mass %):
SiO₂ 34.0-43.0, Al₂O₃ 24.0-30.0; Fe₂O₃ 1.3-3.5; CaO 5.41-0.3; TiO₂ 1.4-17.1; K₂O 0.6-1.0; P₂O₅ 1.4-2.9; Cr₂O₃ 0-2.0; and Li₂O 0-10.2.

The following products were obtained: a. colored glass ceramics in gray and brown colors with a shining and non glossy surface; b. colored gray glass ceramic with a silvery, bronze and light brown surface; c. colored dark brown glass ceramic with a light-brown surface.

### Example 5

### Production of Black Marble-Like Glasses with Aventurine Effect on the Basis of Fly Coal Ash

Ashes I and II were used in combination of other raw materials: SiO₂, CaO, K₂O, Na₂O and Cr₂O₃. The total composition was (mass %): SiO₂ 49.0-55.0; Al₂O₃ 7.0-10.0; Fe₂O₃ 0.6-2.0; CaO 18.0-24.0; TiO₂ 0.4-0.7; K₂₀ 5.0-7.0; P₂O₅ 0.4-1.0; Cr₂O₃ 0.4-6.0; Na₂O 0-10.2.

The glasses were heated in the electrical race at the temperature rage of 1480-1550° C. for 2-6 hours in quartz or alumina crucibles. Aventurie-forming was performed at temperature in the range of 1150-1400° C. for 2-12 hours.

The resulted marble-like glasses had a decorative effect in which the crystals of Cr₂O₃ were uniformly distributed all over (aventurine effect).

### Example 6

### Manufacture of Glass Ceramic and Marble-Like Glasses on the Base of Coal Bottom Ash

The following example demonstrates the applicability of the process for producing glass ceramic and able like glasses from fly coal ash as well as from bottom coal ash.

For manufacture of glass ceramics and marble-like glasses, coal bottom ash have been used, in a composition that was similar to the compositions of coal fly ash presented in Table 1. Composition of materials and technological parameters of manufacture process were as described above for Examples 1, 2, 3, 4 and 5.

The resulting glass ceramics and marble-like glasses did not differ form the above-mentioned resulted compositions and articles that were based on coal fly ash.

### Example 7

### Utilization of Coal Ashes from Different Sources for Optimization of Glass Ceramic Composition

In some cases the coal from a particular source is different either by deficiency or by excessive content of components needed for glass ceramic synthesis. The optimization of compositions of such coal ash by introduction of considerable amount of additional raw materials is not reasonable. A better method is to use coal ashes from another source. The following is an example for glass ceramic obtained from coal ashes obtained from USA deposit.

TABLE 2

| Components | Ash I | Ash II | Mixture of two ashes |
|---|---|---|---|
| SiO₂ | 56.4 | 34.4 | 45.4 |
| Al₂O₃ | 26.9 | 16.1 | 21.5 |
| Fe₂O₃ | 5.5 | 11.5 | 8.5 |
| CaO | 1.9 | 27.5 | 14.7 |
| TiO₂ | 2.1 | 1.2 | 1.7 |
| K₂O | 2.9 | 1.1 | 2.0 |
| SO₃ | 0.3 | 1.7 | 1.0 |
| P₂O₅ | 0.2 | 1.8 | 1.0 |
| Coal | 3.8 | 4.7 | 4.2 |

As it seen from Table 2, ash I differs by higher content of SiO₂, Al₂O₃ and lower content of CaO whereas in ash II the opposite is observed. In addition, in ash II the content of FeO₃ is extremely high and it is more complicate to obtain glass ceramics of light tones. The mixing of I and II ashes in a ratio of 1:1 enables balancing of the content of main components.

After the mixing of the ashes from the different sources calcium carbonate. CaCO₃ has been added. For the catalysis of crystallization, the following have been added separately or in combination: titanium dioxide (TiO₂), chromium oxide (Cr₂O₃) and zinc oxide (ZnO). The resulting composition was (mass %):
SiO₂ 32.0-41.0; Al₂O₃ 16.0-20.0; Fe₂O₃ 5.4-8.0; CaO 16.0-28.0; TiO₂ 1.4-10.0; K₂O 1.4-1.8; P₂O₅ 0.6-0.8; Cr₂O₃ 0-1.5; ZnO 0-7.7.

Following materials have been obtained: painted in mass glass ceramics of light gray, light and dark brown, light and dark green colors with shining and mat surfaces.

### Example 8

### Manufacture of Glass Ceramics and Marble-Like Gasses on the Base of Coal Ashes of Asian and Australian Deposits

For manufacture of glass ceramics and marble-like glasses the coal ashes of Asian and Australian deposits have been used in composition of which are presented in Table 3. As it shown from Table 3, above-mentioned compositions are characterized by low content of calcium oxide CaO and required addition calcium carbonate (CaCO₃).

For the catalysis of crystallization the following oxides were used either separately or in combination: titanium dioxide (TiO₂), chrome oxide (Cr₂O₃), zinc oxide (ZnO), manganese oxide (MnO₂), and zinc sulfide (ZnS). The resulting composition was (mass %):

SiO₂ 40.2-56,7; Al₂O₃ 16-28.3; Fe₂O₃ 2-9.4; CaO 16.6-22.8; MgO 0.3-0.8; TiO₂ 0.8-10.2; K₂O 0.4-2.3; Na₂O 0.2-0.3; P₂O₅ 0.2-1.5; Cr₂O₃ 0-1.5; ZnO 0-11.2; ZnS 0-5.6; MnO₂ 0-1.5.

TABLE 3

| Components | Content (mass %) |
|---|---|
| SiO₂ | 50.2-70.9 |
| Al₂O₃ | 20.2-35.4 |
| Fe₂O₃ | 4.0-11.7 |
| CaO | 0.6-2.8 |
| MgO | 0.4-1.0 |
| TiO₂ | 1.0-1.4 |
| K₂O | 0.6-2.9 |
| Na₂O | 0.2-0.5 |
| SO₃ | 0.2-2.6 |
| P₂O₅ | 0.2-1.8 |

Technological operations are similar to those described in Example 1.

Following materials have been obtained: painted mass glass ceramics and marble-like glasses in light gray, light and dark brown, light and dark green, yellow and creme colors with shining and mat surface.

Preparation of Anorthite/TiO₂ Glass-Ceramic Using the Crystallization Regime of the Present Invention

Standard crystallizations regimes were found to be unsatisfactory for implementing the teachings of the present invention on an industrial scale due to the high percentage of rejected glass-ceramic plates that were cracked or had inferior physical properties, reaching up to about 80% in some batches.

To reduce the number of rejected glass-ceramic plates, a batch of glass-ceramic plates was manufactured using the crystallization regime of the present invention as depicted in FIG. 3.

Coal ash III was obtained from the Rutenberg Power Plant (Ashkelon, Israel), the plant burning coal supplied by TotalFinaElfS.A, South Africa. The composition of coal ash III was SiO₂ (46.5% by weight), Fe₂O₃ (3.7% by weight), Al₂O₃ (30.1% by weight), TiO₂ (1.6% by weight), CaO (10% by weight), MgO (1.9% by weight), SO₃ (2.3% by weight), Na₂O (0.2 by weight), P₂O₅ (2.2 by weight), and K₂O (0.4% by weight).

Rutile sand was obtained from Richards Bay Iron and Titanium (PTY) Ltd. (Richards Bay, Republic of South Africa). The composition of the Rutle sand was TiO₂ (89% by weight), Fe₂O₃ (2.5% by weight), 7.12 (2% by weight), P (0.04% by weight). S (0.008% by weight), SiO₂ (3% by weight), Al₂O₃ (0.88% by weight), CaO (0.25% by weight), MgO (0.08% by weight), Cr₂O₃ (0.14% by weight), V₂O₅ (0.45% by weight), MnO (0.03% by weight) and Acs (0.35% by weight).

CaCO₃ was obtained from Negev Industrial Minerals, Lid. (Omer, Israel).

Preparation of Anorthite/TiO₂ Glass-Ceramic

79 kg coal ash III, 8 kg-Rutile sand and 13 kg CaCO₃ were comminuted and mixed together to make an oxide mixture.

100 kg of the oxide mixture was placed in a MG-300 gas-fired glass-melting furnace (Falomi Glass Furnaces, Empoli, Italy) and heated to and maintained at 900° C. with continuous mixing and the introduction of air for a period of 1 hour to convert residual elemental canon to volatile CO₂.

After all elemental carbon was volatilized, the oxide mixture was heated to 1350° C. and thereafter from 1350° C. to 1520° C. at a rate of between 50° C. hour⁻¹ and 100° C. hour⁻¹ in a. The melt was maintained at 1520° C. for 120 minutes to ensure thorough melting, convective mixing and the conversion of CaCO₃ to CaO.

The mixture was cooled to 1450° C. at a rate of 100° C. hour⁻¹ and poured into a plurality of press molds to form 10 mm thick curved plates of 300 mm×250 mm and a curvature equivalent to that of a 400 mm cylinder.

The molten glass was cooled to 725° C. at a rate of 100° C. hours' and maintained at 725° C. for one hour. The temperature was then increased at a monotonic rate from 725° C. to 900° C. over a period of 6 hours (a rate of −29° C. hour). After the 6 hours, the temperature was then increased at a monotonic rate from 900° C. to 950° C. over a period of 8 hours (a rate of 6.25° C. hour⁻¹). After the 8 hours, the thus-produced glass-ceramic was allowed to cool from 950° C. to 600° C. over a period of 12 hours (a rate of −29° C. hour⁻¹) before removal from the furnace.

It was found that batches of glass-ceramic plates manufactured using the above crystallization regime had a very low percentage of rejected glass-ceramic plates, typically less than about 5%.

The density of the glass-ceramic plates thus produced was roughly 2.7 g cm⁻³. It is clear to one skilled in the art that the glass-ceramic contained 8.9% by weight TiO₂, 39.2% by weight SiO₂, 25.3% by weight Al₂O₃ and 16.2% by weight CaO. The weight ratio CaO to SiO₂ was 2.43 and the weight ratio CaO to Al₂O₃ was 1.57. The ratio SiO₂/Al₂O₃/CaO was 49:31:20, close to the desired 43:37:20 ratio of Anorthite.

### REFERENCES

1) Overview of Coal Combustion Products (CCPs) and the American Coal Ash Association (ACAA) by Samuel S. Tyson, P. E., Executive Director ACAA for National Coal Ash Board, Tel-Aviv, Israel, Jul. 19-20, 2000.
2) P. W. McMillan, Glass Ceramics, 2.sup.nd Ed. (Academic Press, London, 1979).
3) A. L. Berezhnoi, Glass Ceramics and Photositalls (Plenum, N.Y., 1970).
4) Glasses and Glass-Ceramics, ed. M. H. Lewis (Chapman and Hall, London, 1989).
5) High Performance Glasses, ed. M. Cable and J. M. Parker (Blackie, Glasgow, 1992).
6) P. F. James, Glass ceramics: new compositions and uses, J. Non-Cryst. Solids 181 (1995) 1-15.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method for producing a crystalline material comprising:
a) providing ash;
b) melting said ash so as to form a molten mixture; and
c) devitrifying said molten mixture so as to produce the crystalline material wherein said molten mixture includes between about 25.0% and about 57-0% by weight SiO₂; between about 29.0% and about 45.0% by weight Al₂O₃; between about 0.3% and about 10% by weight Fe₂O₃; between about 5.4% and about 34.0% by weight CaO; between about 0.6% and about 24.0% by weight TiO₂; between about 0.2% and about 15.0% by weight K₂O; and between about 0.3% and about 13.0% by weight P₂O₅.

2. The method of claim 1, wherein said ash comprises an ash selected from the group consisting of fly ash, bottom ash, coal ash, municipal incinerator ash and combinations thereof.

3. The method of claim 1, wherein said ash comprises a combination of ashes from difference sources.

4. The method of claim 1, further comprising:
d) prior to (b), heating said ash at a temperature for a period of time so as to remove residual carbon.

5. The method of claim 4, wherein said temperature is between about 650° C. and about 700° C.

6. The method of claim 4, wherein said period of time is between about 2 and about 10 hours.

7. The method of claim 1, further comprising:
e) prior to (c), adding at least one glass-forming agent so as to be a component of said molten mixture.

8. The method of claim 7, wherein at least one said glass-forming agent is selected from the group consisting of SiO₂, Al₂O₃, Li₂O, MgO, Na₂O, CaO and K₂O.

9. The method of claim 1, further comprising:
f) prior to (c), adding at least one crystallization catalyst so as to be a component of said molten mixture.

10. The method of claim 9, wherein at least one said crystallization catalyst is selected from the group consisting of TiO₂, Cr₂O₃, ZnO, CeO₂, MnO₂, and ZrO₂.

11. The method of claim 1, further comprising:
g) prior to (c), adding at least one additional substance as component of said molten mixture, the at least one additional substance selected from the group consisting of CaCO₃, Al₂O₃, technical Al₂O₃, magnesium salts, calcium salts, lithium salts, SiO₂, CaO, Na₂O, Cr₂O₃.

12. The method of claim 1, wherein said molten mixture includes at least about 35.0% by weight SiO₂.

13. The method of claim 1, wherein said molten mixture includes less than about 50.0% by weight SiO₂.

14. The method of claim 1, wherein said molten mixture includes at least about 30.0% by weight Al₂O₃.

15. The method of claim 1, wherein said molten mixture includes les than about 36.0% by weight Al₂O₃.

16. The method of claim 1, wherein said molten mixture includes at least about 1.4% by weight Fe₂O₃.

17. The method of claim 1, wherein said molten mixture includes less than about 6-0% by weight Fe₂O₃.

18. The method of claim 1, wherein said molten mixture includes at least about 10.0% by weight CaO.

19. The method of claim 1, wherein said molten mixture includes less than about 30.0% by weight CaO.

20. The method of claim 1, wherein said molten mixture includes at least about 1.3% by weight TiO₂.

21. The method of claim 1, wherein said molten mixture includes less than about 15-2% by weight TiO₂.

22. The method of claim 1, wherein said molten mixture includes at least about 0.3% by weight K₂O.

23. The method of claim 1, wherein said molten mixture includes less than about 11% by weight K₂O.

24. The method of claim 1, wherein said molten mixture includes at least about 14% by weight P₂O₅.

25. The method of claim 1, wherein said molten mixture includes less than about 6.8% by weight P₂O₅.

26. A method for producing a crystalline material comprising:
a) providing ash;
b) melting said ash so as to form a molten mixture; and
c) devitrifying said molten mixture so as to produce the crystalline material wherein said molten mixture consists essentially of group II oxides, group III oxides, group IV oxides, group V oxides and lanthanoid oxides, and
wherein said molten mixture includes between about 25.0% and about 57.0% by weight SiO₂; between about 24.0% and about 45.0% by weight Al₂O₃; between about 0.3% and about 10% by weight Fe₂O₃; between about 5.4% and about 34-0% by weight CaO; between about 0.6% and about 24.0% by weight TiO₂; between about 0.2% and about 15.0% by weight K₂O; and between about 0.3% and about 13.0% by weight P₂O₅ and is substantially devoid of ZnO.

27. A method for producing a crystalline material comprising:
a) providing ash;
b) melting said ash so as to form a molten mixture; and
c) devitrifying said molten mixture so as to produce the crystalline material wherein said molten mixture includes between about 25.0% and about 57.0% by weight SiO₂; between about 24.0% and about 45.0% by weight Al₂O₃; between about 0.3% and about 10% by weight Fe₂O₃; between about 28% and about 34.0% by weight CaO; between about 0.6% and about 24.0% by weight TiO₂; between about 0.2% and about 15.0% by weight K₂O; and between about 0.3% and about 13.0% by weight P₂O₅.

28. A method for the manufacture of a crystalline object, comprising:
a) providing a furnace comprising at least one chamber, within said chamber a mold containing a substrate, and a heating controller configured to control the rate of heating said chamber;
b) using said heating controller to raise the temperature of said chamber to a first temperature T1 so as to melt said substrate;
c) using said heating controller to reduce the temperature of said chamber to a second temperature T2 so as to allow formation of nucleation centers in said molten substrate;
d) using said heating controller to increase said chamber temperature from said second temperature T2 to a third temperature T3 at a first rate;
e) using said heating controller to increase said chamber temperature from said third temperature T3 to a fourth temperature T4 at a second rate; and
f) allowing said substrate to crystallize, yielding the crystalline object wherein said second rate is substantially lower than said first rate.

29. The method of claim 28, fierier comprising subsequent to (c):
g) using said heating controller to maintain said chamber temperature at said temperature T2 for a period of time sufficient to allow the formation of nucleation centers in said molten substrate.

30. The method of claim 28, further comprising subsequent to (e):
h) using said heating controller to maintain said chamber temperature at least at said temperature T4 for a period of time sufficient to allow said crystallization of said substrate.

31. The method of claim 28, wherein said furnace is a gas-fired furnace.

32. The method of claim 28, wherein said substrate is a glass composition.

33. The method of claim 28, wherein said increase from said second temperature T2 to said third temperature T3 is monotonic.

34. The method of claim 28, wherein said increase from said third temperature T3 to said fourth temperature T4 is monotonic.

35. The method of claim 32, wherein said first rate is between about 10° C. h⁻¹ and about 60° C. h⁻¹.

36. The method of claim 35, wherein said first rate is between about 20° C. h⁻¹ and about 40° C. h⁻¹.

37. The method of claim 32, wherein said second rate is between about 2° C. h⁻¹ and about 15° C. h⁻¹.

38. The method of claim 37, wherein said second rate is between about 3° C. h⁻¹ and about 10° C. h⁻¹.

39. The method of claim 28, wherein said first rate is at least twice said second rate.

40. The method of claim 28, wherein said fit rate is at least three times greater than said second rate.
